(19) United States
(12) Patent Application Publication
(10) Pub. No.: US 2023/0190564 A1
(43) Pub. Date: Jun. 22, 2023

(54) A DEVICE FOR PASSIVE EXERCISING OF A HUMAN LEG

(71) Applicants: Atul Madhusudan KHERDE, Pune (IN); Shilpa Nandkishor GOSAVI, Pune (IN)

(72) Inventors: Atul Madhusudan KHERDE, Pune (IN); Shilpa Nandkishor GOSAVI, Pune (IN)

(21) Appl. No.: 16/634,907

(22) PCT Filed: Aug. 2, 2018
(86) PCT No.: PCT/IB2018/055817

§ 371 Date: Jan. 29, 2020

(30) Foreign Application Priority Data
Aug. 3, 2017 (IN) 201721027640

(51) Int. Cl. A61H 1/02; A61H 1/00

(52) U.S. Cl. CPC A61H 1/0266; A61H 1/005; A61H 2201/164; A61H 2201/1207; A61H 2201/1678; A61H 2201/1436; A61H 2201/0192; A61H 2201/1671; A61H 2201/5066; A61H 2201/1238; A61H 2209/00; A61H 2201/0157; A61H 2201/0149; A61H 2201/165

(57) ABSTRACT

The present disclosure relates to the field of exercising equipment. A device (100, 200, 300, 400, 500, 600) disclosed in the present disclosure increases the reverse blood flow rate, i.e., flow rate of blood from legs towards heart. The device (100, 200 300, 400, 500, 600) includes a pedal (125, 220, 330, 420, 520, 630) configured to support a foot of a leg thereon. The device (100, 200, 300, 400, 500, 600) includes a drive mechanism (140, 250, 350, 530) to oscillate the pedal (125, 220, 330, 420, 520), thereby rocking the foot about the axis of the ankle joint to cause natural movement of the foot as during walking.

### FIELD

The present disclosure relates to the field of passive exercising equipment.

### DEFINITIONS

As used in the present disclosure, the following terms are generally intended to have the meaning as set forth below, except to the extent that the context in which they are used indicate otherwise.

The expression ‘passive exercise’ used hereinafter in the complete specification refers to an exercise in which body parts of an individual are moved by another individual, a machine and/or any other external force.

The expression ‘dorsiflexion’ used hereinafter in the complete specification refers to, but is not limited to, the movement or flexion of the ankle joint in which toes of the leg are pulled towards the shin of the leg.

The expression ‘plantar flexion’ used hereinafter in the complete specification refers to, but is not limited to, the movement or flexion of the ankle joint in which toes point downwards and the heel is pulled towards the calf of the leg.

The expression ‘inversion’ used hereinafter in the complete specification refers to, but is not limited to, the movement in the Subtalar joint of a foot, in which the sole of the foot faces inwards.

The expression ‘eversion’ used hereinafter in eversion refers to, but is not limited to, the movement in the Subtalar joint of a foot, in which the sole of the foot faces outwards.

### BACKGROUND

The background information herein below relates to the present disclosure but is not necessarily prior art.

Primarily, two blood pumping mechanisms exist in a human body. A primary blood pumping mechanism pumps blood from the heart to remaining parts of the human body, whereas a peripheral blood pumping mechanism pumps blood from other parts of the body back towards the heart. The peripheral blood pumping mechanism particularly involves muscles that pump blood back to the heart. In case of legs, the muscles in the lower leg portion facilitate pumping of blood back to the heart. The pumping of blood back to heart is achieved when an individual performs the movements known as dorsiflexion, plantar flexion, inversion and eversion. All such movements are executed when the foot of the leg is moved about an axis of the ankle joint of the leg. More specifically, while performing such movements, the muscles in the lower leg portion compress the veins present between the muscles, which results in pumping of blood back to the heart. Thus, it is the movement of the foot about the ankle joint that drives the flow of blood from the deep leg veins back to the heart.

During the course of a normal day, these movements are performed while walking, running, pedaling and similar activities. However, during prolonged periods of inactivity, such as standing or sitting without any foot movement, the lower leg movement is practically absent. Thus, the muscles in the lower leg portion remain inactive which results in accumulation of blood in the lower foot. This may eventually lead to ailments such as varicose veins and deep vein thrombosis.

A preventive measure for the condition described above is regular walking. Due to sedentary nature of work, such as in case of desk jobs, an individual is required to sit for extended periods with hardly any pedal movement. Pedaling a bicycle or treading on a treadmill requires ample exercise of leg muscles. Treading on a treadmill, in fact, exercises all walking muscle groups. However, such equipments consume significant space. This obviates their use in office setups. Moreover, a user cannot simultaneously work on a desk while using these equipments. In order to use exercise equipments such as a treadmill or a bicycle, separate time needs to be dedicated. In other words, individuals with a sedentary lifestyle are deprived of the chance to move around on feet, and hence, become prone to sedentary lifestyle related diseases like Chronic Venous Diseases including varicose veins and further complications.

Equipment such as automated foot massagers are known in the art. However, the massagers only perform a rubbing or a kneading action on superficial muscles and joints of the body, primarily to relieve tension or pain. Such foot massagers do not move the foot about the ankle joint, more specifically, the foot massagers do not cause the walking action on the calf muscles required for peripheral blood pumping.

Conventional devices for passive exercising perform a see-saw movement of a foot placed thereon. However, such a see-saw movement may cause abrasion or attrition of the knee joint, when used continuously.

There is, therefore, felt a need of a device that alleviates the abovementioned shortcomings of the conventional arrangements.

### OBJECTS

Some of the objects of the present disclosure, which at least one embodiment herein satisfies, are as follows:

An object of the present disclosure is to provide a device for passive exercising of a human leg.

Another object of the present disclosure is to provide a device that improves blood flow from legs towards heart.

Yet another object of the present disclosure is to provide a device that is easy to use.

Yet another object of the present disclosure is to provide a device that can be used while doing regular desk work, thereby eliminating need of dedicating time for exercise of legs.

Another object of the present disclosure is to provide a device that is portable.

Yet another object of the present disclosure is to provide a device that is usable by passengers on long-duration flights or vehicles.

Yet another object of the present disclosure is to provide a device that does not require skilled personnel to operate and monitor the device.

Other objects and advantages of the present disclosure will be more apparent from the following description, which is not intended to limit the scope of the present disclosure.

### SUMMARY

The present disclosure envisages a device for passive exercising of a human leg. The device comprises a pedal, a drive mechanism, a guiding mechanism. The pedal is configured to support a foot of a leg. The drive mechanism includes a prime mover, and configured to oscillate the pedal. The guiding mechanism guides the pedal during oscillatory motion of the pedal. In an operative configuration, the device is configured to rock the foot placed on the pedal about the axis of the ankle joint of the leg to simulate natural movement of the foot during walking.

In accordance with first aspect of the present disclosure, the guiding mechanism comprises a base and a pair of supports. The supports extend from the base, and are arranged in a spaced apart configuration. The pedal is disposed between the supports, and connected to each of the supports at pivot points. The pedal is configured to oscillate about an axis of the pivot points.

According to second aspect of the present disclosure, the guiding mechanism comprises a support and an arcuate slot. The support has a base portion and a pair of walls extending from the base portion. The arcuate slot is configured on each of the walls. The pedal is disposed between the walls, and is supported on two pairs of rolling supports. The rolling supports have rollers disposed in the arcuate slots.

According to third aspect of the present disclosure, the device comprises a pair of pedals. The guiding mechanism comprises a base, a pair of supports, and a pair of hollow shafts. The pair of supports extends from the base, and is arranged in a spaced apart configuration. The pair of hollow shafts passes through holes configured on the supports. Each of the pedals is connected to a first end of one of the shafts. Each of the pedals is configured to oscillate about the longitudinal axis of the shaft under influence of the shaft.

According to fourth aspect of the present disclosure, the device comprises a pair of pedals. The guiding mechanism comprises a base and a pair of supports extending from the base in a spaced apart configuration. The pedals are connected to the supports at pivot points in one-to-one relationship. The pedals are configured to oscillate about the axis of the pivot points. The drive mechanism is coupled to each of the pedals.

According to fifth aspect of the present disclosure, the guiding mechanism comprises a rigid member configured to be removably tied to the shin of a leg. The pedal is hingeably connected to the rigid member, and is configured to support a foot of a leg thereon. The pedal is configured to oscillate about the junction of the pedal and the rigid member.

According to sixth aspect of the present disclosure, the guiding mechanism comprises a base and a control unit. The drive mechanism comprises a plurality of pneumatic or hydraulic or electrically actuated cylinders mounted on the base via a first plurality of ball and socket joints. The pedal is mounted on the plurality of cylinders via a second plurality of ball and socket joints. The control unit is configured to control the operation of the plurality of cylinders to oscillate the pedal about the axis of, ankle joint together with or independently of the subtalar joint of a foot rested on the pedal and produce desired movement patterns.

### BRIEF DESCRIPTION OF THE ACCOMPANYING DRAWING

A device for passive exercising of a human leg, of the present disclosure, will now be described with the help of the accompanying drawing, in which:

FIG. 1 illustrates an isometric view of the device, in accordance with first aspect of the present disclosure;

FIG. 2 illustrates an isometric view of the device depicting a first extreme position, in accordance with second aspect of the present disclosure;

FIG. 3 illustrates an isometric view of the device depicting a second extreme position, in accordance with second aspect of the present disclosure;

FIG. 4 illustrates a front view of a support and an intermediate link of the device, in accordance with second aspect of the present disclosure;

FIG. 5 illustrates a schematic front view of the device, in accordance with third aspect of the present disclosure;

FIG. 6 illustrates an isometric view of the device, in accordance with fourth aspect of the present disclosure;

FIG. 7 illustrates an isometric view of the device, in accordance with fifth aspect of the present disclosure; and

FIG. 8 illustrates an isometric view of the device, in accordance with sixth aspect of the present disclosure.

### LIST OF REFERENCE NUMERALS

100, 200, 300, 400, 500, 600—Device

105—Base/Housing

108—Operative top wall

110—Operative bottom wall

112—Side walls

114—Slot

120—Pair of supports

122—Pivot points

125—Pedal

128—Resting surface

130—Connecting portion

140—Mechanism

145—Prime mover

150—Crank

160—Connecting rod

165—Tilt adjusting plate

170—Tilt locking arrangement

175—Axis of pivot points

205—Support

207—Base portion

209—Pair of walls

215—Arcuate slot

220—Pedal

223—Resting surface

225—Side walls

230—Rolling support

240—Intermediate link

242—Elongated slot

250—Mechanism

254—Crank

256—Connecting rod

260—Bracket

270—Tilt adjusting mechanism

275—Center of curvature of arcuate slot

305—Base

310—Pair of supports

320—Hollow shafts

330—Pedal

332—Resting surface

334—Connecting portion

340—Intermediate link

350—Mechanism

352—Prime mover

354—Crank

356—Connecting rods

370—Rigid rod

375—Longitudinal axis of shaft

405—Pair of rails

410—Base

415—Pair of supports

420—Pedal

510—Rigid member

520—Pedal

530—Mechanism

535—Spacer

540—Straps

545—Prime mover

550—Indicating members

555—Degree Marking

605—Base

615—Pneumatic or hydraulic or electrically actuated cylinders

625—First plurality of ball and socket joints

630—Pedal

635—Second plurality of ball and socket joints

### DETAILED DESCRIPTION

Embodiments, of the present disclosure, will now be described with reference to the accompanying drawing.

Embodiments are provided so as to thoroughly and fully convey the scope of the present disclosure to any person skilled in the art. Numerous details, are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, integers, steps, operations, elements, modules, units and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

When an element is referred to as being “mounted on,” “engaged to,” “connected to,” or “coupled to” another element, it may be directly on, engaged, connected or coupled to the other element. As used herein, the term “and/or” includes any and all combinations of one or more of the associated listed elements.

The terms first, second, third, etc., should not be construed to limit the scope of the present disclosure as the aforementioned terms may be only used to distinguish one element, component, region, layer or section from another component, region, layer or section. Terms such as first, second, third etc., when used herein do not imply a specific sequence or order unless clearly suggested by the present disclosure.

Terms such as “inner,” “outer,” “beneath,” “below,” “lower,” “above,” “upper,” and the like, may be used in the present disclosure to describe relationships between different elements as depicted from the figures.

The present disclosure envisages a device for passive exercising of a human leg. The device comprises a pedal, a drive mechanism, and a guiding mechanism. The pedal is configured to support a foot of the leg. The drive mechanism includes a prime mover, and is configured to oscillate the pedal. The guiding mechanism guides the pedal during oscillatory motion of the pedal. In an operative configuration, the device is configured to rock the foot placed on the pedal about the axis of the ankle joint of the leg to cause natural movement of the foot as during walking.

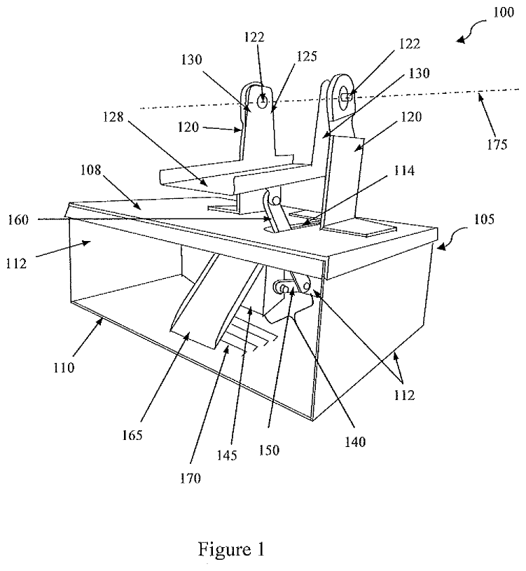

The device, of the present disclosure, is now described with reference to non-limiting FIG. 1 through FIG. 8.

Referring to FIG. 1, a device 100, in accordance with first aspect of the present disclosure is shown.

The device 100 comprises a guiding mechanism, a pedal 125, and a driving mechanism 140. The guiding mechanism comprises a base 105, and a pair of supports 120. In an embodiment, the base 105 is a housing having an operative top wall 108, an operative bottom wall 110, and side walls 112. The operative top wall 108 is hingeably connected to one of the side walls 112 and can be set at different angles of tilt.

The pair of supports 120 extends from the base 105, more specifically from the operative top wall 108 of the base 105. The pair of supports 120 is arranged in a spaced apart configuration.

Further, the pedal 125 is configured to support a foot, and is disposed between the supports 120. The pedal 125 is connected to each of the supports 120 at pivot points 122 and is pivotable about the axis 175 of the pivot points 122. More specifically, the pedal 125 is configured to oscillate about the axis 175 of the pivot points 122. The oscillatory motion of the pedal 125 results in rocking motion of the foot placed on the pedal 125 about the axis of the ankle joint of the leg, thereby simulating natural movement of the foot as during walking. The path of the oscillatory motion of the pedal 125 is similar to the oscillatory motion of a pendulum of a wall clock.

The pedal 125 has a resting surface 128 which supports the foot of the leg and a connecting portion 130. The connecting portion 130 extends from each of the two opposite edges of the resting surface 128, and facilitates connection of the pedal 125 with the supports 120. The distance between the resting surface 128 and the pivot joints 122, more specifically the height of the connecting portion 130, is determined such that the pivot points 122 and the ankle joint of the leg supported on the pedal 125 are collinear. This arrangement facilitates movement of the foot about the axis of the ankle joint thereof when the pedal 125 is in oscillatory motion about the axis 175 of the pivot points 122. The rocking motion of the foot causes the dorsiflexion and plantar flexion of the ankle.

The vertical distance between the pivot points 122 and an operative base portion, i.e., the resting surface 128, of the pedal 125 is adjustable to accommodate variation in the height of ankle joint from a sole of different users. The device 100 includes a height adjusting mechanism configured to alter the vertical distance between the pivot points 122 and the resting surface 128.

In an embodiment, vertical distance between the pivot axis 175 and an operative base portion, i.e., the resting surface 128, of the pedal 125 ranges from 40 mm to 130 mm.

The drive mechanism 140 is configured to facilitate controlled oscillatory motion of the pedal 125.

In an embodiment, the drive mechanism 140 includes a prime mover 145, a crank 150, and a connecting rod 160. The crank 150 is connected to an output shaft of the prime mover 145. The connecting rod 160 is connected to the free end of the crank 150 and the pedal 125, more specifically to the connecting portion 130 of the pedal 125.

The prime, mover 145, can be operated electrically or non-electrically. In an embodiment, the prime mover 145 is selected from the group consisting of an electric motor, a pneumatic motor, a hydraulic motor, and a battery. In another embodiment, the prime mover 145 is an electric motor.

In another embodiment, the prime mover 145 and the crank 150 are disposed within the housing 105. Further, the housing 105 includes a slot 114 configured on the operative top wall 108 of the housing 105. The slot 114 provides passage to the connecting rod 160.

The dimensions and connections of the crank 150 and the connecting rod 160 are determined such that the rotation of crank 150 results in rocking movement of the pedal 125. The pedal 125 is in oscillatory motion about the axis of the pivot points 122 to rock the foot about an axis of the ankle joint of the leg. In an embodiment, the maximum angle of oscillation of the pedal 125 about the axis 175 of the pivot points 122 ranges from +40° to −40° from mean position of the pedal 125.

Although the oscillatory movement of the pedal 125 is achieved by the drive mechanism 140, any other suitable mechanism for oscillating the pedal 125 is well within the scope and ambit of the present disclosure.

The device 100 further comprises a tilt adjusting mechanism disposed between the top wall 108 and the bottom wall 110 of the housing 105. The tilt adjusting mechanism is configured to adjust angular distance between the top wall 108 and the bottom wall 110, more specifically the angle at which the pedal 125 is presented to a user sitting on a chair. In an embodiment, the tilt adjusting mechanism includes a tilt adjusting plate 165 connected to an inner portion of the top wall 108 and a tilt locking arrangement 170 configured on the bottom wall 110. The angular distance between the top wall 108 and the bottom wall 110 can be adjusted by locking the tilt adjusting plate 165 in different locking slots of the tilt locking arrangement 170.

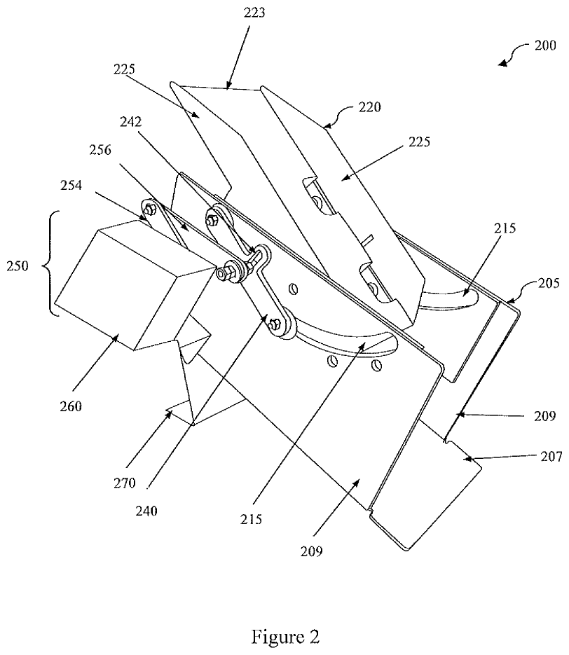

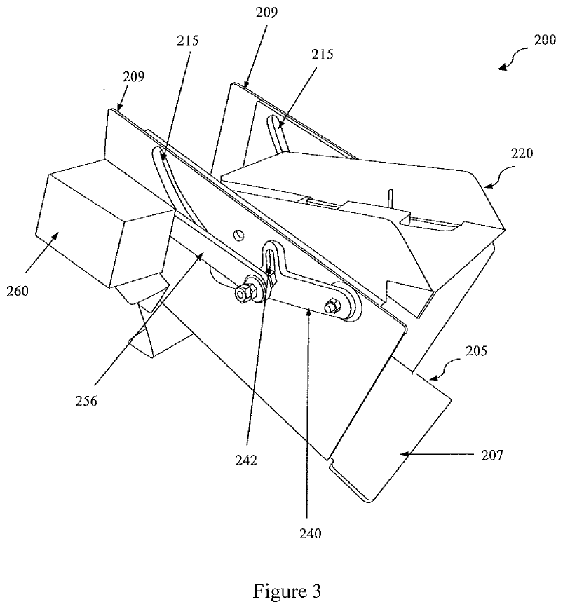

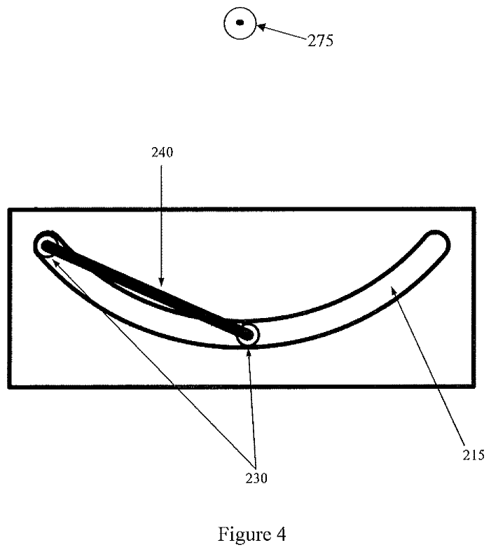

Referring to FIG. 2, FIG. 3, and FIG. 4, a device 200, in accordance with second aspect of the present disclosure is shown.

The device 200 comprises a pedal 220, a guiding mechanism, and a drive mechanism 250. The guiding mechanism comprises a support 205 and an arcuate slot 215. The support 205 has a base portion 207 and a pair of walls 209 extending from the base portion 207. In an embodiment, the pair of walls 209 extends from opposite edges of the base portion 207.

The arcuate slot 215 is configured on each of the walls 209.

The pedal 220 is configured to support a foot thereon. The pedal 220 is disposed between the walls 209, and is supported on two pairs of rolling supports 230. The rolling supports 230 include rollers which are disposed in the arcuate slots 215. More specifically, the rollers of one pair of rolling supports 230 are disposed in one arcuate slot 215 configured on one wall 209, whereas the rollers of other pair of rolling supports are disposed in another arcuate slot 215 configured on opposite wall. The rollers of respective pair of rolling supports 230 are in a spaced apart configuration.

In an embodiment, the pedal 220 has a resting surface 223 for supporting the leg thereon and a pair of side walls 225 extending from opposite edges of the resting surface 223.

The mechanism 250 includes a prime mover, a crank 254 connected to the prime mover, a connecting rod 256 connected to a free end of the crank 254, and an intermediate link 240 connected to the connecting rod 256 and one pair of rolling supports 230. In an embodiment, the intermediate link 240 has an elongated slot 242 configured thereon to facilitate connection between the connecting rod 256 and the intermediate link 240. The elongated slot 242 is for adjustment of the degrees of motion. The elongated slot 242 facilitates connection of the connecting rod 256 at different points in the slot 242 from the center of curvature 275 of the arcuate slot 215 which results in altering the travel path of the rollers or degrees through which the rollers travel in the arcuate slot 215.

The operation of the drive mechanism 250 is similar to the mechanism 140 described in previous paragraphs.

The prime mover, the crank 254, and the connecting rod 256 displace the intermediate link 240. The displacement of the intermediate link 240 displaces the rollers of one pair of rolling supports 230 connected to the intermediate link 240 in the arcuate slot 215. The movement of the rollers is guided by the arcuate path of the slot 215. The displacement of the rollers displaces the pedal 220 such that the pedal 220 oscillates and rocks the foot to simulate the natural movement of the foot around the ankle joint axis during walking.

The dimensions and connections of the crank 254 and the connecting rod 256 are determined such that the rotation of crank 254 results in oscillatory motion of the pedal 220. The oscillatory motion of the pedal 220 results in rocking movement of the foot about the axis of the ankle joint of the leg.

The dimensions and the angle subtended by the arcuate slot 215 are determined such that the pedal 220 oscillates to rock the foot about the axis of the ankle joint when the intermediate link 240 and the rolling support 230 are displaced. In an embodiment, the angle subtended by the arcuate slot 215 at the center thereof ranges from 40° to 130°.

The prime mover of the device 200 can be operated electrically or non-electrically. In an embodiment, the prime mover is selected from the group consisting of an electric motor, a pneumatic motor, a hydraulic motor, and a battery. In another embodiment, the prime mover is an electric motor. The device 200 includes a bracket 260 attached to the support 205, and configured to support the prime mover, preferably an electric motor.

In another embodiment, the device 200 comprises a tilt adjusting mechanism 270 connected to an operative bottom portion of the support 205, and configured to alter the tilt or angular distance of the support 205 from ground.

In yet another embodiment, the device 200 includes a height adjusting mechanism configured to accommodate feet of different users having different heights of ankle axis from soles of their feet.

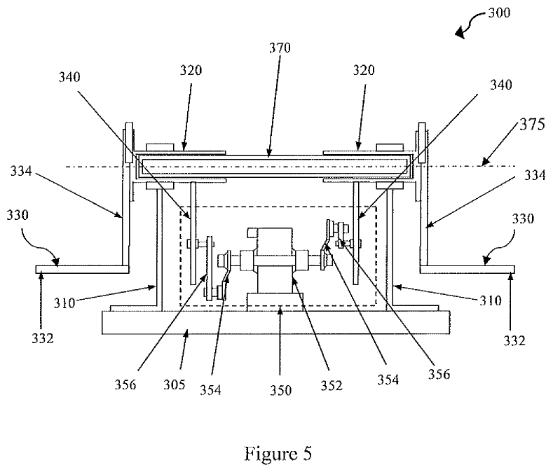

Referring to FIG. 5, a device 300, in accordance with third aspect of the present disclosure is shown.

The device 300 comprises a pair of pedals 330, a guiding mechanism, and a drive mechanism 350. The guiding Mechanism comprises a base 305, a pair of supports 310, and a pair of hollow shafts 320. The pair of supports 310 extends from the base 305, and is arranged in a spaced apart configuration. The pair of hollow shafts 320 passes through holes configured on the supports 310. More specifically, one of the shafts 320 passes through the hole configured on one support, whereas other hollow shaft passes through the hole configured on the other support.

Each of the pedals 330 is configured to support a foot of a leg thereon. Each of the pedals 330 is connected to a first end of one of the shafts 320. More specifically, one of the pedals 330 is connected to the free end of one shaft 320, whereas other pedal 330 is connected to the free end of another shaft 320. Each of the pedals 330 is configured to oscillate about the longitudinal axis 375 of respective shafts 320 under influence of the shaft 320. The longitudinal axis 375 of each of the shafts 320 passes through the ankle joint of the leg supported on respective pedal 330 connected to that shaft.

In an embodiment, the mechanism 350 includes an intermediate link 340, a prime mover 352, a pair of cranks 354 coupled to an output shaft the prime mover 352, and a pair of connecting rods 356 connected to a free end of the cranks 354 and the intermediate links 340.

The prime mover, the cranks 354, and the connecting rods 356 are configured to displace the intermediate links 340 to angularly displace the respective shafts 320, thereby facilitating oscillatory movement of the pedals 330. The oscillatory movement of the pedals results in rocking motion of the foot supported on respective pedal 330 about the axis of the ankle joint of the leg.

The prime mover of the device 300 can be operated electrically or non-electrically. In an embodiment, the prime mover is selected from the group consisting of an electric motor, a pneumatic motor, a hydraulic motor, and a battery. In another embodiment, the prime mover is an electric motor.

In an embodiment, the pair of cranks 354 is coupled to the output shaft of the prime mover 352 at an angle of 180° with respect to each other. This arrangement facilitates simulation of natural walking movement of two legs. More specifically, due to such arrangement, when one pedal is at its extreme forward position, the other pedal is at its extreme backward position. The forward and backward positions are similar to the positions of two legs during walking.

Each of the intermediate links 340 has an elongated slot configured thereon to facilitate connection between the intermediate links 340 and respective connecting rods 356. The elongated slot facilitates the connecting rod 356 to get connected to the intermediate link 340 at different distances from the shafts axis 375. This facilitates alteration in the angular displacement of the shafts 320, and hence alteration in amplitude of movement of the pedal 330.

In an embodiment, the device 300 comprises a rigid rod 370 passing through the hollow shafts 320. The rigid rod 370 acts as a floating axle. The rigid rod 370 supports the shafts 320 thereon, and prevents bending of the shafts 320 by transferring the bending moment at one support to, the other support.

Each of the pedals 330 has a resting surface 332 configured to support the foot of the leg thereon, and a connecting portion 334 extending from the resting surface 332 and connected to one of the shafts 320. Further, the connecting portion 334 includes a height adjusting mechanism configured to alter distance between the resting surface 332 and the shaft 320. Such arrangement helps to align the axis of the ankle joint of the leg of different individual users with longitudinal axis 375 of the shaft 320.

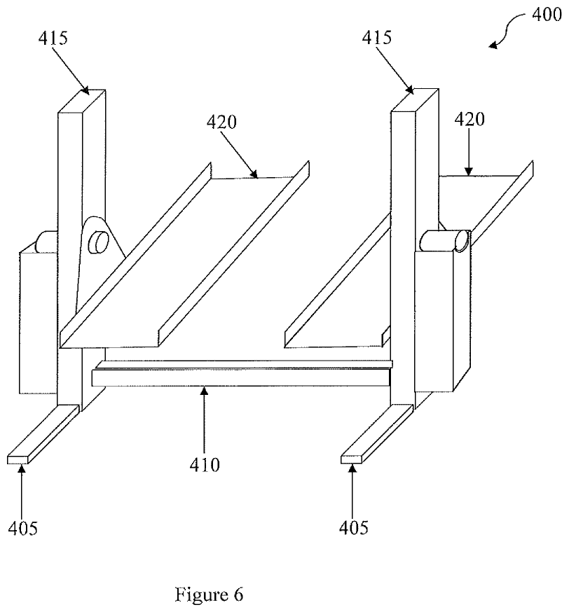

Referring to FIG. 6, a device 400, in accordance with fourth aspect of the present disclosure is shown.

In first embodiment, the device comprises a pair of pedals 420, a guiding mechanism, and a drive mechanism coupled to each of the pedals 420. The guiding mechanism includes a base 410 and a pair of supports 415. The pair of supports 415 extends from the base 410 in a spaced apart configuration.

In second embodiment, the guiding mechanism comprises a pair of rails 405, wherein the base 410 is slidably mounted on the pair of rails 405. The pair of supports 415 extends from the base 410 in a spaced apart configuration.

Each of the pedals 420 is configured to support a foot of a leg. The pair of pedals 420 is disposed between the supports 415. The pedals 420 are connected to the supports 415 at pivot points in one-to-one relationship. More specifically, one pedal of the pair of pedals 420 is connected to one support 415 of the pair of supports, while other pedal of the pair of pedals 420 is connected to other support of the pair of supports 415. The pedals 420 are configured to oscillate about the axis of the pivot points. The pivot points and the ankle joints of the legs supported on the pedal 420 are collinear.

More specifically, the axis of the ankle joint and the axis passing through the pivot points are aligned. Thus, rocking of the pedal 420 about axis of respective pivot points angularly displaces the leg about the axis of the ankle joint thereof, thereby simulating the natural movement of the legs during walking.

The drive mechanisms coupled to the pedals 420 in one-to-one relationship, and configured to independently facilitate oscillatory motion of pedals 420.

Each of the mechanisms includes a prime mover and a plurality of linkages connected between the prime mover and the respective pedal 420.

The prime mover of the device 400 can be operated electrically or non-electrically. In an embodiment, the prime mover is selected from the group consisting of an electric motor, a pneumatic motor, a hydraulic motor, and a battery. In another embodiment, the prime mover is an electric motor.

The mechanisms for oscillating the pedals 420 can be any of the mechanisms described in previous paragraphs. In case of mechanism 140, the mechanism 140 can be separately connected to an operative bottom portion of each of the pedals 420. In case of the mechanism 350, the pedals 420 can be connected to the supports 415 via hollow shafts. The hollow shafts can be angularly displaced using two separate mechanisms 350.

The configuration of each of the pedals 420 is similar to the configuration of pedals

The device 400 is particularly useful in case there is restricted space available. For example, the device 400 can be used in airplanes. In case of airplanes, the device 400 can be kept below a user's own seat or can be mounted on the supports of a seat in front of the user. In case the device 400 needs to be connected to a seat in front of the user's seat, the pedals 420 can be connected to two legs of the seat to which the device 400 is to be tied. Further, the pedals 420 can be connected to the seat using clamps, thereby eliminating the need of drilling the legs of the seat.

In case of second embodiment, due to use of the rails 405, the device 400 can be kept below a user's seat and can be pulled out whenever required.

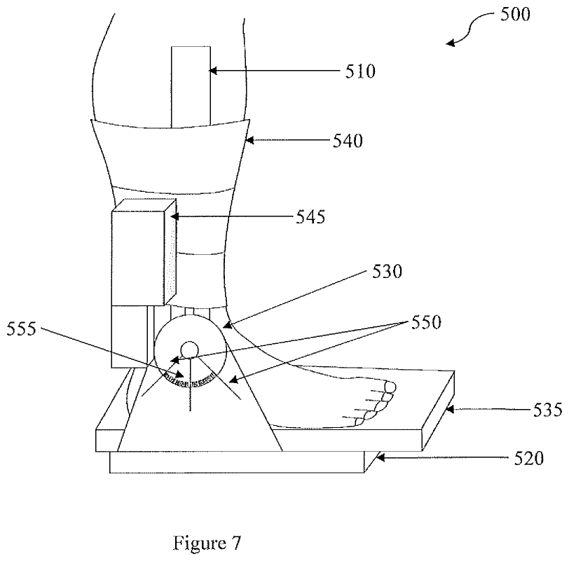

Referring to FIG. 7, a device 500, in accordance with fifth aspect of the present disclosure is shown.

The device 500 comprises a guiding mechanism, a pedal 520, and a drive mechanism 530. The guiding mechanism includes a rigid member 510 configured to be removably tied to a shin of a leg. The rigid member 510 can be tied using Velcro straps 540. The pedal 520 is hingeably connected to the rigid member 510. The pedal 520 acts as a foot plate and supports a foot of a leg thereon. The pedal 520 is configured to oscillate about the junction of the pedal 520 and the rigid member 510. The rigid member 510 and the pedal 520 are configured such that the axis of the junction of the pedal 520 and the rigid member 510 is aligned with the axis of the ankle joint of the leg supported by the pedal 520. The drive mechanism 530 is configured to facilitate controlled oscillatory motion of the pedal 520 about the junction.

In an embodiment, the device 500 includes a spacer 535 disposed on the pedal 520. The spacer 535 facilitates adjustment of a user's foot according to the ankle height such that the axis of the ankle joint and the axis of the junction of the pedal 520 and the rigid member 510 are aligned.

In an embodiment, the drive mechanism 530 comprises a prime mover 545, a worm and worm wheel, a pair of limit switches, a pair of indicating members 550, and a control unit. The worm wheel is connected to the worm. The prime mover 545 is mounted on the rigid member 510. The worm and worm wheel is connected to an output shaft of the prime mover 545. More specifically, the worm is connected to the output shaft of the prime mover 545, and the worm wheel is engaged with the worm. In an embodiment, the worm wheel is mounted at the junction of the pedal 520 and the rigid member 510. The pedal 520 is connected to the worm wheel, and is configured to displace with the worm wheel.

The prime mover 545 of the device 500 can be operated electrically or non-electrically. In an embodiment, the prime mover 545 is selected from the group consisting of an electric motor, a pneumatic motor, a hydraulic motor, and a battery. In another embodiment, the prime mover 545 is an electric motor.

The indicating members 550 are mounted on the worm wheel at the center thereof, and are angularly displaceable about the center. The indicating members 550 are so mounted such that the indicating members 550 do not cross each other when angularly displaced.

The worm wheel is provided with markings 555. The markings 555 correspond to the angle of oscillation of the pedal 520. Further, indentations or protrusions are configured on the worm wheel which can be sensed by the limit switches.

The limit switches are mounted on the indicating members 550 or are displaceable with the indicating members 550. The limit switches are configured to sense the indentation or protrusion when the same passes over the limit switches. The limit switches are further configured to generate a position signal corresponding to sensed protrusion or indentation. The control unit cooperates with the prime mover 545 and the limit switches. The control unit is configured to receive the generated positional signals from the switches and an input speed from a user. The control unit is further configured to control speed and direction of rotation of the prime mover based on the received positional signals and the input to limit the oscillation of the worm wheel to the degrees set between the two indicating members. Input speed is the oscillatory speed of the pedal 520 desired by the user. Further, the arrangement of the limit switches prevents any undesirable movement of the foot of the leg about the axis of the ankle joint thereof beyond pre-set limits.

The control unit is further configured to control the operating parameters of the device 500 like duration of operation, speed and power of the prime mover, and degrees of motion.

The arrangement of indicating members and the limit switches enable a user to control the angle of oscillation of the pedal 520.

The device 500 is particularly useful for physiotherapy of frozen ankles. The device 500 is configured to operate at ultra-low frequency, wherein each cycle lasts for few seconds.

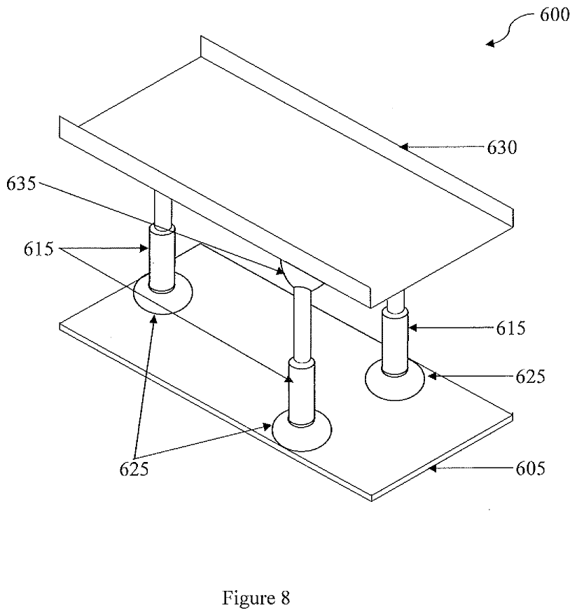

Referring to FIG. 8, a device 600, in accordance with sixth aspect of the present disclosure is shown. The guiding mechanism comprises a base 605 and a control unit. The drive mechanism comprises a plurality of pneumatic or hydraulic or electrically actuated cylinders 615. The cylinders 615 are mounted on the base 605 using a first plurality of ball and socket joints 625. More specifically, each pneumatic cylinder is mounted on the base 605 using one ball and socket joint. Due to first plurality of ball and socket joints 625, the pneumatic cylinders 615 are angularly displaceable with respect to the base 605. Further, a pedal 630 is mounted on the plurality of cylinders 615 via a second plurality of ball and socket joints 635. More specifically, each cylinder is connected to the pedal 630 using one ball and socket joint.

The pedal 630 is oscillated using the cylinders 615 to generate the required position by calculating the pedal 630's plane with reference to the base 605 plane, such that the foot placed on the pedal 630 is rocked about an axis of the ankle joint thereof along with additional motion components for eversion and aversion as desired.

The control unit is configured to control the operation of the plurality of cylinders 615 to oscillate the pedal 630 about the axis of ankle joint of a foot rested on the pedal 630 simultaneously about the axis of the subtalar joint, wherein both movements, i.e., movement of the pedal 630 about the axis of the ankle joint and movement of the pedal 630 about the axis of the subtalar joint, occur independently of each other.

The device described hereinabove is easy to use. User simply has to put a foot of a leg on the pedal, and operate the device. The pedal performs oscillatory motion, thereby rocking the foot placed on the pedal about the axis of the ankle joint of the leg and other motions as per embodiment 600.

The device was tested for finding its effect on the reverse blood flow on a group of 15 persons. Initially, the blood flow from the leg towards the heart in all the persons was measured. Further, the persons were asked to keep their feet on the pedal of the device. The device was then operated and the blood flow from the leg towards the heart in all the persons was again measured. Following Table 1 shown the results of the test.

TABLE 1

| | Blood flow without | Blood flow | Blood |
|---|---|---|---|
| | using the device | without | flow while |
| | (in ml/min) | using the device | using the device |
| | sleeping in a | (in ml/min) in a | (in ml/min) in a |
| No. | prone position | seating position | seating position |
| 1 | 4.8 | 0.6 | 38.2 |
| 2 | 4.9 | 1.2 | 40.1 |
| 3 | 4.2 | 0.4 | 35.8 |
| 4 | 5.2 | 1.6 | 44.6 |
| 5 | 5.1 | 1.3 | 42.2 |
| 6 | 4.9 | 1.2 | 40.7 |
| 7 | 4.7 | 0.6 | 38.2 |
| 8 | 5.2 | 1.6 | 44.7 |
| 9 | 3.9 | 0.4 | 36.1 |
| 10 | 4.3 | 0.7 | 38.6 |
| 11 | 5.1 | 1.7 | 44.7 |
| 12 | 4.9 | 0.7 | 39.1 |
| 13 | 5.1 | 1.3 | 41.6 |
| 14 | 4.9 | 1.2 | 40.2 |
| 15 | 4.8 | 0.9 | 39.8 |

From the above Table 1, it is evident that there was increase in the blood flow from the legs towards the heart in each person after using the device of the present disclosure. Thus, the device increases the reverse blood flow in a body, i.e., from the lower extremities of the body towards the heart.

The device described hereinabove is easy to use. Further, the device can be used while performing regular desk work. The device does not require skilled personnel to operate and monitor. The device is portable, and can be transported to any place.

The device increases the blood flow from legs towards heart, thereby minimizing the risk of various diseases associated with the accumulation of blood in veins of legs.

The device can be used even for a short duration of time. The configuration of device is simple, and does not involve complex mechanisms similar to various exercising equipment in gyms.

The foregoing description of the embodiments has been provided for purposes of illustration and not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

### TECHNICAL ADVANCEMENTS

The present disclosure described herein above has several technical advantages including, but not limited to, the realization of a device for passive exercising of a human leg that:
improves blood flow from legs towards heart;
is easy to use;
can be used while doing regular desk work, thereby eliminating need of dedicating time for exercise of legs;
is portable;
useful for physiotherapy of frozen ankles; and
does not require skilled personnel to operate and monitor the device.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation

1. A device for passive exercising of a human leg, said device comprising:
a pedal configured to support a foot of said leg;
a drive mechanism including a prime mover, said drive mechanism configured to oscillate said pedal; and
a guiding mechanism for guiding said pedal during oscillatory motion of said pedal;
wherein in an operative configuration, said device is configured to rock said foot placed on said pedal about an axis of the ankle joint of said leg to simulate natural movement of said foot during walking.

2. The device as claimed in claim 1, wherein:
said guiding mechanism comprises:
a base; and
a pair of supports extending from said base, and arranged in a spaced apart configuration; and
said pedal is disposed between said supports, and connected to each of said supports at pivot points, said pedal configured to oscillate about an axis of said pivot points.

3. The device as claimed in claim 2, wherein said drive mechanism includes:
a crank connected to said prime mover; and
a connecting rod connected to a free end of said crank and to said pedal.

4. The device as claimed in claim 3, wherein said base is a housing having an operative top wall, an operative bottom wall, and side walls, wherein said operative top wall is hingeably connected to one of said side walls.

5. The device as claimed in claim 4, wherein said prime mover and said crank are disposed within said housing, and said pair of supports is mounted on said operative top wall of said housing, wherein said housing includes a slot configured on said operative top wall of said housing, said slot is configured to provide passage to said connecting rod.

6. The device as claimed in claim 4, which comprises a tilt adjusting mechanism disposed between said operative top wall and bottom wall of said housing, and configured to adjust angular distance between said operative top wall and said operative bottom wall.

7. The device as claimed in claim 2, wherein vertical distance between said pivot point and an operative base portion of said pedal ranges from 40 mm to 130 mm.

8. The device as claimed in claim 2, wherein said device includes a height adjusting mechanism configured to adjust the vertical distance between said pivot point and an operative base portion of said pedal.

9. The device as claimed in claim 2, wherein the maximum angle of oscillation of said pedal about said pivot points ranges from +40° to −40° from mean position of said pedal.

10. The device as claimed in claim 1, wherein:
said guiding mechanism comprises:
a support having a base portion and a pair of walls extending from said base portion; and
an arcuate slot configured on each of said walls;
said pedal is disposed between said walls and supported on two pairs of rolling supports, said rolling supports having rollers disposed in said arcuate slots.

11. The device as claimed in claim 10, wherein said drive mechanism comprises:
an intermediate link connected to one of said two pairs of rolling supports;
a crank connected to said prime mover; and
a connecting rod connected to a free end of said crank and said intermediate link.

12. The device as claimed in claim 10, wherein an angle subtended by said arcuate slot from the center thereof ranges from 40° to 130°.

13. The device as claimed in claim 11, which comprises a bracket attached to said housing, and configured to support said prime mover.

14. The device as claimed in claim 10, wherein said device comprises a tilt adjusting mechanism connected to an operative bottom portion of said support, and configured to alter tilt or angular distance of said support from ground.

15. The device as claimed in claim 11, wherein said intermediate link has an elongated slot configured thereon to facilitate connection between said connecting rod and said intermediate link at different points from the center of curvature of said arcuate slot.

16. The device as claimed in claim 1, wherein:
said guiding mechanism comprises:
a base;
a pair of supports extending from said base and arranged in a spaced apart configuration; and
a pair of hollow shafts passing through holes configured on said supports; and
said device comprises a pair of pedals, each of said pedals connected to a first end of one of said shafts, each of said pedals configured to oscillate about the longitudinal axis of said shaft under influence of said shaft, wherein the longitudinal axis of said shaft and an axis of the ankle joint of a leg placed on each of said pedals are aligned.

17. The device as claimed in claim 16, wherein said drive mechanism includes:
an intermediate link connected to a second end of each of said shafts;
a pair of cranks coupled to an output shaft said prime mover; and
a pair of connecting rods connected to a free end of said cranks and said intermediate links.

18. The device as claimed in claim 17, wherein said pair of cranks is coupled to said output shaft at an angle of 180° with respect to each other.

19. The device as claimed in claim 17, wherein each of said intermediate links has an elongated slot configured thereon to facilitate connection between said intermediate links and said connecting rods.

20. The device as claimed in claim 16, which includes a rigid rod passing through said shafts, and configured to support said shafts thereon.

21. The device as claimed in claim 16, wherein each of said pedals has a resting surface configured to support a leg thereon, and a connecting portion extending from said resting surface and connected to one of said shafts,

22. The device as claimed in claim 21, wherein said connecting portion includes a height adjusting mechanism configured to alter distance between said resting surface and an axis of said shaft.

23. The device as claimed in claim 1, wherein:
said guiding mechanism comprises:
a base; and
a pair of supports extending from said base in a spaced apart configuration;
said device comprises a pair of pedals disposed between said supports, wherein said pedals are connected to said supports at pivot points in one-to-one relationship, said pedals configured to oscillate about said pivot points; and
said drive mechanism is coupled to each of said pedals, and comprises a plurality of linkages connected between the prime mover and said pedal.

24. The device as claimed in claim 23, wherein said guiding mechanism comprises a pair of rails, and said base is slidably mounted on said pair of rails.

25. The device as claimed in claim 1, wherein said guiding mechanism comprises a rigid member configured to be removably tied to a shin of a leg, and said pedal is hingeably connected to said rigid member.

26. The device as claimed in claim 25, wherein said drive mechanism comprises:
a worm and a worm wheel connected to said worm, wherein said worm is connected to an output shaft of said prime mover, and said pedal is coupled to said worm wheel and configured to be displaced with said worm wheel;
a pair of limit switches configured to sense a, position of indicating members, and generate a position signal corresponding to each sensed extreme position; and
a control unit cooperating with said prime mover and said limit switches, said control unit configured to receive said generated positional signals from said switches and an input speed from a user, said control unit further configured to control speed and direction of rotation of said prime mover based on said received positional signals and said input to limit the oscillation of said worm wheel to the degrees set between the two indicating members.

27. The device as claimed in claim 1, wherein:
said guiding mechanism comprises:
a base; and
a control unit; and
said drive mechanism comprises a plurality of pneumatic or hydraulic or electrically actuated cylinders mounted on said base via a first plurality of ball and socket joints;
said pedal is mounted on said plurality of said cylinders via a second plurality of ball and socket joints;
wherein said control unit is configured to control the operation of said plurality of cylinders to oscillate said pedal about the axis of ankle joint of a foot rested on said pedal and simultaneously about the axis of the subtalar joint with both movements occurring independently of each other.

28. The device as claimed in claim 1, wherein said prime mover is selected from the group consisting of an electric motor, a pneumatic motor, a hydraulic motor, and a battery.
